(19) United States
(12) Patent Application Publication
(10) Pub. No.: US 2016/0329996 A1
(43) Pub. Date: Nov. 10, 2016

(54) FAILURE SENSITIVITY ANALYSIS

(71) Applicant: Infineon Technologies AG, Neubiberg (DE)

(72) Inventors: Oezlem Karaca, Munich (DE); Jerome Kirscher, Munich (DE); Georg Pelz, Ebersberg (DE)

(21) Appl. No.: 14/706,417

(22) Filed: May 7, 2015

(51) Int. Cl. H04L 1/24

(52) U.S. Cl. CPC H04L 1/244

(57) ABSTRACT

In one example, a method includes receiving, by one or more processors, a virtual model of an electrical system that includes a plurality of signals and one or more output signals; analyzing, by the one or more processors, the virtual model to determine, for each respective signal of the plurality of signals, data indicating a sensitivity of a particular output signal of the one or more output signals to a failure of the respective signal; and outputting, by the one or more processors and for display, a visual representation of the determined data that indicates the sensitivities of the particular output signal to the failures of the signals.

### TECHNICAL FIELD

This disclosure relates to the electronic systems, and in particular, to electronic systems that are designed to comply with requirements on the quality of the electronic system.

### BACKGROUND

In modern electronics, great demands on quality assessment are impacting semiconductor companies. For example, the ISO 26262 standard is becoming an important reference for ASIL accreditation (ASIL: Automotive Safety Integrity Level). Safety requirements may have a non-negligible impact in the development phase on many sensitive parameters, increasing the effort and time required for design and verification, reporting and review and accreditation and consequently the cost of the product.

### SUMMARY

In general, the techniques described in this disclosure are related to determining the sensitivity of one or more output signals of an electronic system to failures of one or more other signals of the electronic system.

In one example, a method includes receiving, by one or more processors, a virtual model of an electrical system that includes a plurality of signals and one or more output signals; analyzing, by the one or more processors, the virtual model to determine, for each respective signal of the plurality of signals, data indicating a sensitivity of a particular output signal of the one or more output signals to a failure of the respective signal; and outputting, by the one or more processors and for display, a visual representation of the determined data that indicates the sensitivities of the particular output signal to the failures of the plurality of signals.

In another example, a computer-readable storage medium stores instructions that, when executed by one or more processors of a system, cause the one or more processors to: receive a virtual model of an electrical system that includes a plurality of signals and one or more output signals; analyze the virtual model to determine, for each respective signal of the plurality of signals, data indicating a sensitivity of a particular output signal of the one or more output signals to a failure of the respective signal; and output, for display, a visual representation of the determined data that indicates the sensitivities of the particular output signal to the failures of the plurality of signals

In another example, a system includes a memory storing a virtual model of an electrical system that includes a plurality of signals and one or more output signals; and one or more processors configured to: analyze the virtual model to determine, for each respective signal of the plurality of signals, data indicating a sensitivity of a particular output signal of the one or more output signals to a failure of the respective signal; and output, for display, a visual representation of the determined data that indicates the sensitivities of the particular output signal to the failures of the plurality of signals

The details of one or more embodiments are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example electrical system simulator configured to determine sensitivities of one or more output signals of a virtual model to failures of other signals of the virtual model, in accordance with one or more techniques of this disclosure.

FIG. 2 is a schematic diagram illustrating details of an example system for which a virtual model may be created to enable analysis of sensitivities of the output signals of the system to failures of other signals of the system, in accordance with one or more techniques of this disclosure.

FIGS. 3A and 3B are schematic diagrams illustrating details of an example system for which a virtual model may be created to enable analysis of sensitivities of the output signals of the system to failures of the other signals of the system, in accordance with one or more techniques of this disclosure.

FIG. 4 is a graph illustrating example data indicating sensitivities of one output signal of a system to failures of other signals of the system, in accordance with one or more techniques of this disclosure.

FIG. 5 is a flowchart illustrating exemplary operations of a simulator to determine data indicating sensitivities of one or more output signals of a system to failures of other signals of the system, in accordance with one or more techniques of this disclosure.

### DETAILED DESCRIPTION

Any system may fail due to failure of one or more constituent sub-systems or hardware elements. Some failures may propagate to a severe failure, which may have severe consequences. For instance, the failure of a power steering system may prevent a user of the power steering system from avoiding an obstacle. As such it may be desirable to perform failure analysis on a system to ensure that the system complies with one or more safety targets (i.e., absence of unreasonable risk) or other quality targets. However, the failure of some sub-systems or hardware elements may not necessarily result in a severe failure to an overall system. As such, when performing failure analysis, it may be desirable to determine which sub-system or hardware element failures are likely to cause a severe system-level failure.

The effort and time for pre-silicon verification is extended by for example by safety analysis (i.e., safety analysis of a system before the system is physically created), where three types of failure analysis methods can be distinguished: analytical, formal/model-based, and simulation-based. In either case, the objective of safety analysis is to expose cause-consequence relationships between failure sources in the hardware, i.e. hardware faults, and safety requirements, in order to identify failure sources which are most likely to violate safety requirements. In this context, analytical methods which are based on the analyzers' judgment and experience are likely to result in safety analysis with lacking objectivity and are particularly not sufficient when compliance with stringent safety requirements is demanded, such as when complying with ISO 26262. As such, some standards, such as ISO 26262, recommend the use of simulation-based methods and emphasize the fault injection technique. Although fault simulation may be useful for the numeric evaluation of failure effects, fault simulation may generally be subject to many simulation runs when varying component-level faults are evaluated. Additionally, many simulation runs with different faults may be needed to quantify diagnostic coverage. These economic challenges may be addressed by behavioral fault modeling for reduction of simulation time and use of analytical tools as failure source reference in order to prevent redundant fault simulations. Behavioral models of electric circuits are generally models by which it is aimed to capture the functional behavior of the electronic circuit under the condition that the behavioral model is less complex and less simulation-intensive like the initial model (i.e., an initial transistor-level model). That is the behavioral model is an abstracted version of the electric circuit.

However, both approaches suffer from subjectivity, which may degrade the objectivity of the results. As one example, a tester may believe that a particular fault is highly unlikely to occur because the particular faults never occurred in the preceding products. As another example, a tester may believe that a short circuit from gate A to gate B is very unlikely because of the metric distance between the transistors on the chip, which may cause the tester to assess the fault differently when another tester. Additionally, regarding behavioral models, it is up to the personal experience and expertise of the modeler to decide which level of abstraction is sufficient in order to perceive a useful functional behavior of the electronic circuit. Therefore, it may be desirable to reduce the number of simulation runs which in turn may reduce the verification time without compromising the objectivity of the testing results.

In accordance with one or more techniques of this disclosure, signals of a virtual model of a system may be filtered to identify how sensitive system-level signal failures are to signal failures within the system. The virtual model may include a plurality of interconnected hardware elements (e.g., resistors, transistors, integrated circuits, and the like) that generate one or more output signals. One or more processors may analyze signals of the virtual model (e.g., voltage levels, current levels, digital signals) at interconnections of the hardware to determine, for each respective signal, data indicating an effect that a failure of the respective signal has on the output signal. In some examples, the data may indicate a relative effect that a failure of a particular signal has on the output signal as compared to the effects other signals have on the output signal. For instance, the data may indicate that a failure of a first signal of the virtual model has a stronger effect on the output signal than a failure of a second signal of the virtual model. In some examples, as opposed to determining data indicating the effect that a failure of a single signal has on an output signal, the one or more processors may determine data indicating a combined effect that failures of multiple signals have on an output signal. In this way, the one or more processors may determine how sensitive system-level signal failures are to signal failures within the system.

In some examples, in addition to or in place of the electrical signals of the virtual model (e.g., voltage levels, current levels, digital signals), the one or more processors may analyze other types of signals. As one example, the one or more processors may analyze thermal signals of the virtual model, such as temperature and heat flow. As another example, the one or more processors may analyze mechanical signals.

The identified signals of the system (which system-level signal failures are most sensitive to) may then be used to select components for more intensive analysis. In other words, as opposed to applying intensive analysis techniques (e.g., fault injection) to every component, techniques of this disclosure enable application of intensive analysis techniques to components whose failures have the strongest effect on system-level signal failures. In this way, the runs needed to failure simulations of the virtual model may be reduced without compromising the objectivity of the testing results. Also in this way, safety analysis can be performed on a system without performing explicit and exhaustive analysis on components of the system.

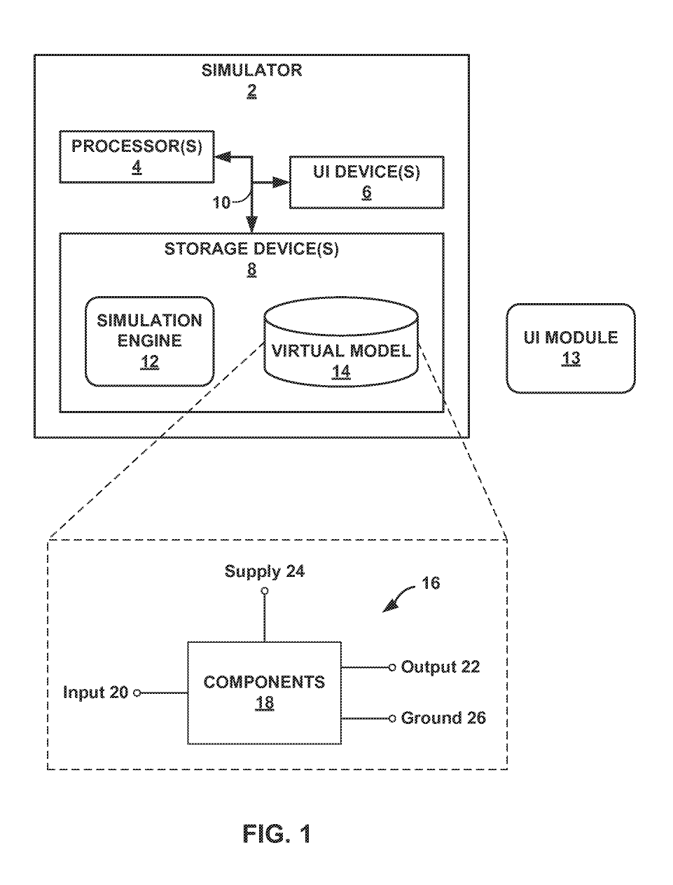

FIG. 1 is a block diagram illustrating an example electrical system simulator configured to determine sensitivities of an output signal of a virtual model to failures of other signals of the virtual model, in accordance with one or more techniques of this disclosure. As illustrated in FIG. 1, simulator 2 includes one or more processors 4, one or more user interface (UI) devices 6, and one or more storage devices 8. Each of components 4, 6, and 8 may be interconnected (physically, communicatively, and/or operatively) via communication channels 10 for inter-component communications. In some examples, communication channels 10 may include a system bus, network connection, interprocess communication data structure, or any other channel for communicating data. One or more of storage devices 8, in some examples, may include simulation engine 12, UI module 13, and virtual model 14.

Processors 4, in one example, are configured to implement functionality and/or process instructions for execution within simulator 2. For example, processors 4 may be capable of processing instructions stored in one or more of storage devices 8. Examples of processors 4 may include any one or more microprocessors, digital signal processors (DSPs), application specific integrated circuits (ASICs), field programmable gate arrays (FPGAs), or any other equivalent integrated or discrete logic circuitry, as well as any combinations of such components.

Simulator 2, in some examples, may also include one or more UI devices 6. In some examples, one or more of UI devices 6 can be configured to output content, such as simulation results. For instance, one or more of UI devices 30 may be configured to display video data at a display and/or output audio data from speakers. In addition to outputting content, one or more of UI devices 6 may be configured to receive tactile, audio, or visual input. Some examples of UI devices 6 include video displays, speakers, keyboards, touch screens, mice, cameras, and the like.

Simulator 2, in some examples, may also include UI module 13. UI module 13 can perform one or more functions to receive, content, such as UI data from other components associated with simulator 2 and cause one or more of UI devices 6 to output the content. In some examples, UI module 13 may be configured to receive an indication of input, such as user input, and send the indications of the input to other components associated with simulator 2, such as simulation engine 12.

Simulator 2, in some examples, may also include virtual model 14, which may be a virtual representation of an electrical system. As illustrated in FIG. 1, virtual model 14 may comprise a virtual model of electrical system 16. For instance, virtual model 14 may include virtual components which may represent actual components 18 of electrical system 16. In some examples, the virtual components may include mathematical models that replicate the behavior of actual (i.e., real-world) components. Examples of virtual model 14 include, but are not limited to, SPICE models, Verilog models, VHDL models, and any other electronic circuit simulation model.

As shown in FIG. 1, electrical system 16 may include components 18, input 20, output 22, supply 24, and ground 26. Components 18 may comprise a plurality of interconnected hardware elements. Some example hardware elements that may be included in components 18 include, but are not limited to, resistors, capacitors, inductors, integrated circuits, microcontrollers, and any other type of hardware element capable of being included in an electrical system. As discussed above, virtual model 14 may include virtual components to represent the actual physical components 18. Additionally, virtual model 14 may include a representation of the interconnections between components 18. For instance, virtual model 14 may include data that indicates that a first pin of a first component of components 18 is connected to a first pin of a second component of components 18.

Each of the interconnections between the hardware elements of components 18 may be capable of carrying a signal. Some example signals may include, but are not limited to, analog signals (e.g., voltage levels and/or current levels) and digital signals (e.g., signed 8-bit, unsigned 16-bit, or any other such digital signal). In some examples, signals carried by some of the interconnections may be referred to as signals within the system. For instance, signals other than the output signal or the input signal may be referred to as other signals within the system.

Components 18 may generally perform one or more functions to generate an output signal based on an input signal. For instance, components 18 may generate an output signal at output 22 based on an input signal received at input 20. In some examples, components 18 may receive power from supply 10 and reference ground 12.

Simulator 2, in some examples, may also include simulation engine 12. Simulation engine 12 may comprise software instructions that are executable by processors 4 to simulate the performance of an electrical system by analyzing a virtual model of the electrical system. However, simulation engine 12 may also be implemented via hardware or firmware, as well as with any combination of hardware, software and firmware. In the example of FIG. 1, stimulation engine 12 may simulate the performance of electrical system 16 by analyzing virtual model 14. For instance, processors 4 may utilize mathematical models of components 18 to simulate how components 18 would process an input signal received at input 20 to generate an output signal for output at output 22. In some examples, virtual components 8 may receive power from virtual supply 10 and reference virtual ground 12.

In some examples, simulation engine 12 may be executable by processors 4 to perform failure analysis on a system to e.g., determine which sub-system or hardware element failures are likely to cause a severe system-level failure. For instance, simulation engine 12 may be executable by processors 4 to perform failure analysis on a virtual model by using fault simulation (e.g., fault-injection). As discussed above, the amount of time elapsed while simulation engine 12 performs fault simulation (i.e., the simulation time) may generally be long, (i.e. between several minutes and days, depending on the virtual model) and especially when component-level faults are evaluated. Additionally, in some examples, simulation engine 12 may need to perform many simulation runs with varying faults, which may further increase the overall fault simulation time. In some examples, the simulation time of simulation engine 12 may be reduced by behavioral fault modeling and/or use of analytical tools as failure source reference in order to prevent redundant fault simulations. However, both approaches may suffer from subjectivity, which may degrade the objectivity of the results. Therefore, it may be desirable to reduce the number of simulation runs which in turn may reduce the verification time, without compromising the objectivity of the testing results.

In accordance with one or more techniques of this disclosure, simulation engine 12 may be executable by processors 4 to analyze a virtual model to determine data indicating sensitivities of the output signal to failures of other signals of the virtual model. For instance, simulation engine 8 may analyze signals of virtual model 14 to determine data indicating sensitivities of output signal 22 to failures of the signals of virtual model 14 (which, as discussed above, may represent signals at the interconnections of components 18). In some examples, the data determined by simulation engine 12 may indicate a relative effect that a failure of a particular signal of virtual model 14 would have on output signal 22 as compared to the effects failures other signals of virtual model 14 would have on output signal 22. For instance, the data may indicate that a failure of a first signal of virtual model 14 would have a stronger effect on output signal 22 than a failure of a second signal of virtual model 14. In some examples, as opposed to determining data indicating the effect that a failure of a single signal of virtual model 14 would have on output signal 22, simulation engine 12 may determine data indicating a combined effect that failures of multiple signals of virtual model 14 would have on output signal 22. In this way, simulation engine 8 may determine how sensitive system-level signal failures would be to signal failures within the system.

In some examples, simulation engine 12 may utilize one or more procedures to determine the sensitivity data. As one example, simulation engine 12 may utilize quantitative sensitivity analysis such as variance-based techniques, regression-based techniques, or any other quantitative technique. As another example, simulation engine 12 may utilize qualitative sensitivity analysis, such as screening-based techniques. As another example, simulation engine 12 may utilize other statistical data analysis, such as data mining (e.g., pattern recognition) techniques.

In some examples, the sensitivity data determined by simulation engine 12 may involve a quantitative or qualitative statement on the sensitivity of the output signal towards (i.) single signal alterations and/or (ii.) multiple signal alternations, i.e. interactive alterations. Some examples of the sensitivity data include, but are not limited to, data derived from quantitative sensitivity analysis (e.g., first order sensitivity index Sᵢ and/or total effect index S_{Ti}), data derived from qualitative screening methods, such as Morris screening method, (e.g., first order effect of mean μ of elementary effects and/or total effect Gᵢ).

In some examples, simulation engine 12 may retrieve signal failures in the system model from nominal signal alternations during nominal system behavior. In some examples, simulation engine 12 may induce signal failures in the system model by implementation of additional signal disturbances.

In some examples, if the sensitivity data determined by simulation engine 12 for a particular failure of a particular signal has a high value (i.e., relative to the sensitivity data for other signals), the output signal may be considered to be highly sensitive to the particular failure of the particular signal. Similarly, in some examples, if the sensitivity data determined by simulation engine 12 for a particular failure of a particular signal has a low value (i.e., relative to the sensitivity data for other signals), the output signal may be considered to not be sensitive to the particular failure of the particular signal.

In any case, the identified signals within the system (which system-level signal failures are most sensitive to) may then be used to select components for more intensive analysis, such as analysis via fault-injection. In other words, as opposed to applying intensive analysis techniques (e.g., fault injection) to every component, simulation engine 12 may filter the signals such that intensive analysis techniques may be applied to components whose failures have strong effects on system-level signal failures. As the intensive analysis techniques may not be applied to components whose failures have weak effects on system-level signal failures, simulation engine 12 enables a reduction in the time needed to simulation failures of the virtual model without compromising the objectivity of the testing results. Also in this way, simulation engine 12 enables performance of safety analysis on a system without performing explicit and exhaustive analysis on components of the system.

In some examples, simulation engine 12 may output the data indicating sensitivities of the output signal to failures of the other signals. For instance, simulation engine 12 may cause UI module 13 to output, via one or more of UI devices 6, a graphical user interface that includes a representation of the determined data that indicates the sensitivities that output signal 22 would have to failures of the other signals of virtual model 14.

In some examples, the intensive analysis techniques may be applied by other devices. In some examples, the intensive analysis techniques may be applied by simulation engine 12. For instance, simulation engine 12 may receive, from UI module 14 and via one or more of UI devices 6, user input that indicates a selection of components of virtual model 14 for performance of fault-injection.

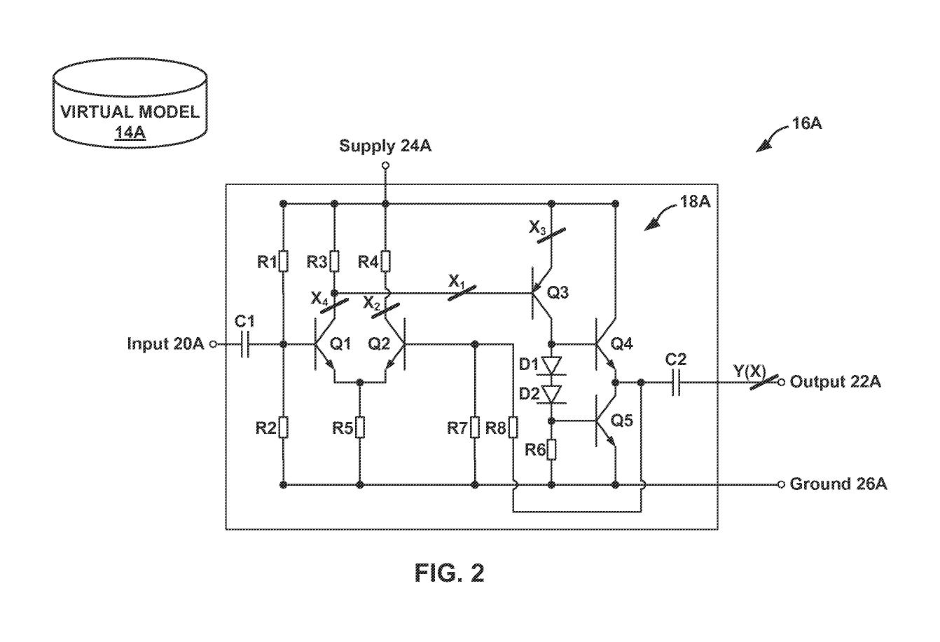

FIG. 2 is a schematic diagram illustrating details of an example system for which a virtual model may be created to enable analysis of sensitivities of an output signal of the system to failures of other signals of the system, in accordance with one or more techniques of this disclosure. Electrical system 16A of FIG. 2 may be an example of electrical system 16 of FIG. 1. As illustrated in FIG. 2, electrical system 16A may include components 18A, input 20A, output 22A, supply 24A, and ground 26A.

Components 18A may be an example of components 18 of FIG. 1. For instance, components 18A may generally perform one or more functions to generate an output signal at output 22A based on an input signal received at input 20A. As illustrated in FIG. 2, components 18A may include resistors R1-R8, capacitors C1 and C2, transistors Q1-Q5, and diodes D1 and D2.

A virtual model, such as virtual model 14A may be created to represent system 16A. As discussed above, in some examples, system 16A need not actually exist for virtual model 14A to be created. In this way, virtual model 14A may be used to model the performance of system 16A without actually constructing system 16A.

Virtual model 14A may include virtual components to represent components 18A. For instance, virtual model 14A may include a virtual resistor for each of resistors R1-R8, a virtual capacitor for each of capacitors C1 and C2, a virtual transistor for each of transistors Q1-Q5, and a virtual diode for each of diodes D1 and D2. Additionally, virtual model 14A may include a representation of the interconnections between components 18A. For instance, virtual model 14A may include data that indicates that a first pin of C1 is connected to input 20A and a second pin of C1 is connected to a first pin of R2, a second pin of R1, and a first pin of Q1.

Each of the interconnections between the hardware elements of components 18A may carry a signal. Some example signals may include, but are not limited to, analog signals (e.g., voltage levels and/or current levels) and digital signals (e.g., signed 8-bit, unsigned 16-bit). Some example, analog signals include, but are not limited to, electrical signals, thermal signals, and mechanical signals. As illustrated in FIG. 2, a subset of the signals of system 16A is labeled as signals x₁-x₄. In the example of FIG. 2, signal x₁ may represent the voltage at a pin (e.g., the base) of transistor Q3, signal x₂ may represent the voltage at a pin (e.g., the collector) of transistor Q2, signal x₃ may represent the voltage at a pin (e.g., the emitter) of transistor Q3, and signal x₄ may represent the voltage at a pin (e.g., the collector) of transistor Q1. Collectively, signals x₁-x₄ may be referred to as a vector of signals x. The output signal y may represent the voltage at output 22A and may be a scalar function of x (i.e., y=y(x).

Signals in x can fail due to a variety of conditions. As one example, signals in x may fail due to hardware faults of one or more of components 18A (e.g., open-circuit, electro-magnetic induction). As another example, signals in x may fail due to parametric variations of components 18A (e.g., varying resistances). Consequently output signal y may fail due to the same reasons. As such, it may be desirable to determine how severely failures of signals in x (and combinations within) will affect output signal y.

In accordance with one or more techniques of this disclosure, simulation engine 12 may analyze virtual model 14A to determine data indicating sensitivities of output signal y to failures of signals of virtual model 14A. In the example of FIG. 2, simulation engine 12 may use Morris' screen method to determine the data. For instance, simulation engine 12 may vary each signal in x one-at-a-time (OAT) and evaluate the relative importance of the signals on output signal y.

Simulation engine 12 may generate a sampling matrix for signals x₁-x₄. Each of signals x₁-x₄ may be one of three states at any given time. In the example of FIG. 2, each of signals x₁-x₄ may be either −1, 0, or 1 (i.e., x1-x4εΩ={−1,0,1}). In some examples, simulation engine 12 may randomize the sampling matrix in accordance with Equation (1), below, where B*: provides one elementary effect per signal, which may be randomly selected, J_{k+1,k} may be a (k+1)×k matrix of 1s, x* may be a randomly chosen ‘base value’ of x, D* may be k-dimensional diagonal matrix in which each element is either +1 or −1 with equal probability, and P* may be a k-by-k random permutation matrix in which each column contains one element equal to 1 and all others equal to 0 and no two columns have 1s in the same position.

$$B *= ( {J}_{k + 1 , 1} x * + \frac{Δ}{2} [ ( 2 B - {J}_{k + 1 , k} ) D * + {J}_{k + 1 , k} ] ) P * \qquad Equation ( 1 )$$

Some example sampling matrices for signals x₁-x₄ which may be generated by simulation engine 12 are provided below in Table (1) and Table (2). To generate the “y from simulation” in each of Table (1) and Table (2), simulation engine 12 may simulate virtual model 14A while adjusting signals x₁-x₄ as shown. For instance, simulation engine 12 may generate y₁₁ as the simulated voltage level at y(x) where x₁ is −1, x₂ is −1, x₃ is 1, and x₄ is −1.

TABLE (1)

| Sample 1 | x₁ | x₂ | x₃ | x₄ | y from simulation |
|---|---|---|---|---|---|
| Variation 1 | −1 | −1 | 1 | −1 | y₁₁ |
| Variation 2 | 0 | −1 | 1 | −1 | y₁₂ |
| Variation 3 | 0 | 0 | 1 | −1 | y₁₃ |
| Variation 4 | 0 | 0 | 0 | −1 | y₁₄ |
| Variation k + 1 = 5 | 0 | 0 | 0 | 0 | y₁₅ |

TABLE (2)

| Sample 2 | x₁ | x₂ | x₃ | x₄ | y from simulation |
|---|---|---|---|---|---|
| Variation 1 | 0 | −1 | 1 | 0 | y₂₁ |
| Variation 2 | −1 | −1 | 1 | 0 | y₂₂ |
| Variation 3 | −1 | 0 | 1 | 0 | y₂₃ |
| Variation 4 | −1 | 0 | 0 | 0 | y₂₄ |
| Variation k + 1 = 5 | −1 | 0 | 0 | 1 | y₂₅ |

In some examples, simulation engine 12 may derive the data (i.e., a sensitivity measure) from the elementary effects for the ith signal. In some examples, simulation engine 12 may determine the elementary effect for the ith signal in accordance with equation (2), below, where x is the vector of signals that are within scaled and discretized parameter space Ω={−1,0,1}, eᵢ is a vector of zeros but with a unit as its i-th component, and Δ is a preselected integer step length.

$${EE}_{i} = \frac{y ( x + {e}_{i} Δ ) - y ( x )}{Δ} \qquad Equation ( 2 )$$

The integer step length may be an abstraction of the actual alternation of the specific signal in x for variation 1 to k+1. As one example, −1 may stand for signal x₁ for −25% of voltage amplitude alternation and 0 for 0% of voltage amplitude alternation and 1 for +10% voltage amplitude alternation. As another example, where the range is {0, 0.5, 1}, still 0 may represent −25%, 0.5 may represent 0%, and 1 may represent +10% amplitude alternation of the signal x₁. For another signal x₂ this may mean for example −50%, 0% and +50% respectively. In other words, the integer steps may be considered abstract representations of the actual alternation that the signals experience. In some examples, such as when using the Morris Screening method, all signals are each alternated by constant percentages (e.g., −25%, 0%, and +25%). In some examples, the signals may each be alternated by varying percentages.

Simulation engine 12 may generate a distribution of the elementary effects. For instance, simulation engine 12 may generate matrix Fᵢ as the distribution of the elementary effects for two samples (i.e., sample 1 as shown in Table (1) and sample 2 as shown in Table (2)) and four signals. An example matrix Fᵢ which may be generated by simulation engine 12 is shown in Equation (3) below, where each i-th column represents the elementary effects of the i-th signal.

$${F}_{i} = ( \begin{matrix}{y}_{11} - {y}_{12} & … & {y}_{14} - {y}_{15} \\ {y}_{21} - {y}_{22} & … & {y}_{24} - {y}_{25}\end{matrix} ) \qquad Equation ( 3 )$$

Simulation engine 12 may determine the relative strength of each i-th signal on the output signal and/or the strength of the i-th signal's interaction with other signals in affecting the output signal. In some examples, simulation engine 12 may determine that the mean μᵢ of i-th column is the relative strength of first order effect of i-th signal on the output signal. In this way, simulation engine 12 may determine, for respective signals of virtual model 14A, data indicating a sensitivity of the output signal to a failure of the respective signal. In some examples, simulation engine 12 may determine that the standard deviation σᵢ of i-th column indicates how strong the i-th signal interacts with other signals in affecting the output signal. In this way, simulation engine 12 may data indicating a sensitivity of the output signal to a combined failure of a first signal of virtual model 14A and a failure of a second signal of virtual model 14A.

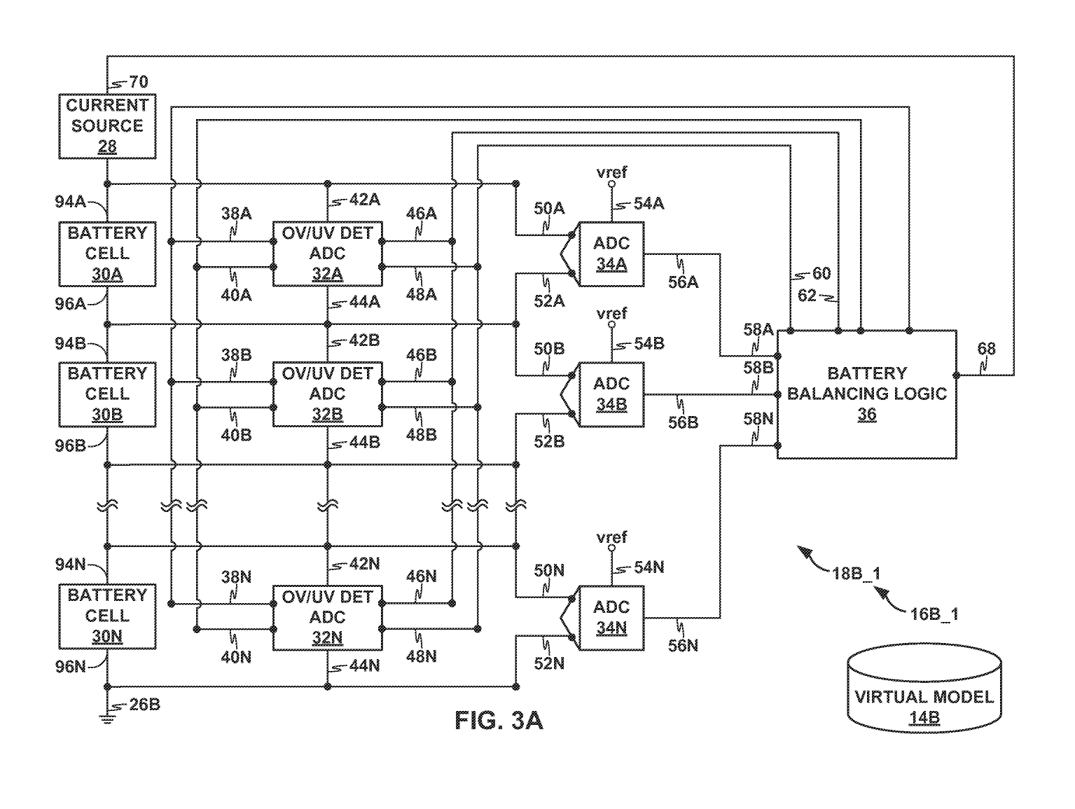

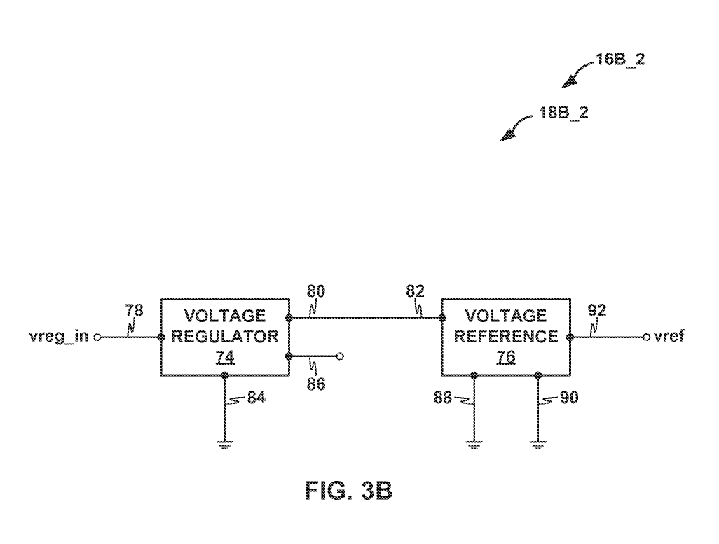

FIGS. 3A and 3B are schematic diagrams illustrating details of an example system for which a virtual model may be created to enable analysis of sensitivities of an output signal of the system to failures of signals of the system, in accordance with one or more techniques of this disclosure. Electrical system 16B_1 of FIG. 3A and electrical system 16B_2 of FIG. 3A are collectively referred to as “electrical system 16B.” Similarly, components 18B_1 of FIG. 3A and components 18B_2 of FIG. 3A are collectively referred to as “components 18B.” Electrical system 16B of FIGS. 3A and 3B may be an example of electrical system 16 of FIG. 1.

Components 18B may be an example of components 18 of FIG. 1. As illustrated in FIGS. 3A and 3B, components 18B may include current source 28, battery cells 30A-30N (collectively, “battery cells 30”), overvoltage (OV)/undervoltage (UV) detector and analog-to-digital converters (ADC) 32A-32N (collectively, “OV/UV detectors and ADCs 32”), ADCs 34A-34N (collectively, “ADCs 34”), battery balancing logic 36, voltage regulator 74, and voltage reference 76.

Together, components 18B may operate as a battery management integrated circuit (IC) module, including battery cells 30. The battery management IC module may monitor various aspects of battery cells 30 (e.g., voltage, temperature) and balance charge across the cells using either active balancing or passive balancing. Additionally, in some examples, the battery management IC may perform constant current battery charging. The analog and mixed-signal functions of the battery management IC module may be performed by ADCs 34 for primary voltage measurement and OV/UV detectors and ADCs 32 for secondary voltage measurement. The primary voltage measurement may be used for precise voltage reading for cell balancing and the secondary voltage measurement may be used for fast cell overvoltage and undervoltage detection. In this context, the primary converter (i.e., ADCs 34) may be considered to be the safety-related hardware element and the secondary converter (i.e., OV/UV detectors and ADCs 32) may be the safety mechanism for the safety-related hardware element (i.e., by preventing safety goal violations due to overvoltage or undervoltage of battery cells 30). In other words, the output signal of system 16B may be considered to be the voltages across battery cells 30B. Additionally, OV/UV detectors and ADCs 32 may act in case of a failure of ADCs 32 to prevent subsequent potential hazard.

A virtual model, such as virtual model 14B may be created to represent system 16B. As discussed above, in some examples, system 16B need not actually exist for virtual model 14B to be created. In this way, virtual model 14B may be used to model the performance of system 16B without actually constructing system 16B.

Virtual model 14B may include virtual components to represent components 18B. For instance, virtual model 14B may include a virtual current source for current source 28, a virtual battery cell for each of battery cells 30, a virtual OV/UV detector and ADC for each of OV/UV detectors and ADCs 32, a virtual ADC for each of ADCs 34, a virtual battery balancing logic for battery balancing logic 36, a virtual voltage regulator for voltage regulator 74, and a virtual voltage reference for voltage reference 76. Additionally, virtual model 14B may include a representation of the interconnections between components 18B.

Each of the interconnections between the hardware elements of components 18A may carry a signal. Some example signals may include, but are not limited to, analog signals (e.g., voltage levels and/or current levels) and digital signals (e.g., signed 8-bit, unsigned 16-bit). As illustrated in FIG. 3, signals of system 16B may include some or all of the following signals:
Digital overvoltage thresholds 38A-38N (detA_ovth<8:0>-detN_ovth<8:0>) (collectively, “digital overvoltage thresholds 38”), which may each be a digital value, such as an eight-bit digital value, that indicates a maximum voltage level across a battery cell of battery cells 30 before the battery cell is considered to be overvoltaged.
Digital undervoltage thresholds 40A-40N (detA_uvth<8:0>-detN_uvth<8:0>) (collectively, “digital undervoltage thresholds 40”), which may each be a digital value, such as an eight-bit digital value, that indicates a minimum voltage level across a battery cell of battery cells 30 before the battery cell is considered to be undervoltaged.
Detector plus voltages 42A-42N (detA_-detN_p) (collectively, “detector plus voltages 42”), which may each be an analog voltage of a plus (i.e., positive) terminal of a battery cell of battery cells 30 as received by an OV/UV detector and ADC of OV/UV detectors and ADCs 32.
Detector minus voltages 44A-44N (detA_m-dctN_m) (collectively, “detector minus voltages 44”), which may each be an analog voltage of a minus (i.e., negative) terminal of a battery cell of battery cells 30 as received by an OV/UV detector and ADC of OV/UV detectors and ADCs 32.
Output cell overvoltage flags 46A-46N (detA_ov<A>-detN_ov<N>) (collectively, “output cell overvoltage flags 46”), which may each be a digital flag output by an OV/UV detector and ADC of OV/UV detectors and ADCs 32 to indicate that a voltage level of a battery cell of battery cells 30 is greater than a maximum voltage level across before the battery cell is considered to be overvoltaged (i.e., the maximum voltage level indicated by a respective digital overvoltage threshold of digital overvoltage thresholds 38).
Output cell undervoltage flags 48A-48N (detA_uv<A>-detN_uv<N>) (collectively. “output cell undervoltage flags 48”), which may each be a digital flag output by an OV/UV detector and ADC of OV/UV detectors and ADCs 32 to indicate that a voltage level of a battery cell of battery cells 30 is less than a minimum voltage level across before the battery cell is considered to be undervoltaged (i.e., the minimum voltage level indicated by a respective digital undervoltage threshold of digital undervoltage thresholds 40).
ADC plus voltages 50A-50N (adcA_p-adcN_p) (collectively, “ADC plus voltages 50”), which may each be an analog voltage of a plus (i.e., positive) terminal of a battery cell of battery cells 30 as received by an ADC of ADCs 34.
ADC minus voltages 52A-52N (adcA_m-adcN_m) (collectively, “ADC minus voltages 52”), which may each be an analog voltage of a minus (i.e., negative) terminal of a battery cell of battery cells 30 as received by an ADC of ADCs 34.
ADC reference voltages 54A-54N (adcA_vref-adcN_vref) (collectively, “ADC reference voltages 54”), which may each be an analog reference voltage (i.e., as output by voltage reference 76) as received by an ADC of ADCs 34.
Output digital fine cell voltages 56A-56N (adcA_o<12:0>-adcN_o<12:0>) (collectively. “output digital fine cell voltages 56”), which may each be a digital value, such as a thirteen-bit digital value, that indicates a voltage level across a battery cell of battery cells 30 as output by an ADC of ADCs 34.
Received digital fine cell voltages 58A-58N (logic_oA<12:0>-logic_oN<12:0>) (collectively, “received digital fine cell voltages 58”), which may each be a digital value, such as a thirteen-bit digital value, that indicates a voltage level across a battery cell of battery cells 30 as received by battery balancing logic 36 (i.e., from ADCs 34).
Received cell undervoltage flags (logic_uv<N:1>) 60, which may each be a digital flag received by battery balancing logic 36 (i.e., from an OV/UV detector and ADC of OV/UV detectors and ADCs 32) to indicate that a voltage level of a battery cell of battery cells 30 is less than a minimum voltage level across before the battery cell is considered to be undervoltaged (i.e., the minimum voltage level indicated by a respective digital undervoltage threshold of digital undervoltage thresholds 40).
Received cell overvoltage flags (logic_ov<N:1>) 62, which may each be a digital flag received by battery balancing logic 36 (i.e., from an OV/UV detector and ADC of OV/UV detectors and ADCs 32) to indicate that a voltage level of a battery cell of battery cells 30 is greater than a maximum voltage level across before the battery cell is considered to be overvoltaged (i.e., the maximum voltage level indicated by a respective digital overvoltage threshold of digital overvoltage thresholds 38).
Output logic disable (logic_disable) 68, which may be a digital flag output by battery balancing logic 36 to cause current source 28 to cease providing current to charge battery cells 30.
Received current source disable (cs_disable) 70, which may be a digital flag receive by current source 28 (i.e., from battery balancing logic 36) to cause current source 28 to cease providing current to charge battery cells 30.
Voltage regulator input (vreg_in) 78, which may be a power supply signal, such as a car battery voltage signal.
Voltage regulator output (vreg_out) 80, which may be a regulated voltage signal as output by voltage regulator 74.
Voltage regulator ground (vreg_gnda) 84, which may be the ground signal used by voltage regulator 74.
Voltage regulator disable (vreg_dis) 86, which may be a digital flag that disables or enables the voltage regulations (i.e., depending on the operating mode of the electronics (charging or idle or etc) the voltage regulator can be disabled or enabled).
Voltage reference input (vref_in) 82, which may be a regulated voltage signal as received by voltage reference 76.
Voltage reference output (vref_out) 92, which may be a reference voltage signal as output by voltage reference 76.
Voltage reference ground (vref_gnda) 88, which may be the ground signal used by voltage reference 76.
Voltage reference ground reference (vref_gnda_ref) 90, which may be a reference ground signal as output by voltage reference 76.
Battery cell plus voltages 94A-94N (collectively, “battery cell plus voltages 94”), which may each be an analog voltage of a plus (i.e., positive) terminal of a battery cell of battery cells 30 as actually present at the plus terminal of the battery.
Battery cell minus voltages 96A-96N (collectively, “battery cell minus voltages 96”), which may each be an analog voltage of a minus (i.e., negative) terminal of a battery cell of battery cells 30 as actually present at the minus terminal of the battery.

Signals in system 16B can fail due to a variety of conditions. As one example, signals in system 16B may fail due to hardware faults of one or more of components 18B (e.g., open-circuit, electro-magnetic induction). As another example, signals in system 18B may fail due to parametric variations of components 18B (e.g., varying resistances). Consequently output signals of system 16B may fail due to the same reasons. For instance, the voltages across battery cells 30 (i.e., the output signals of system 16B) may exceed an overvoltage threshold due do the failures of one or more other signals in system 18B. As such, it may be desirable to determine how severely failures of signals in system 16B (and combinations within) will affect the output signals of 16B.

In accordance with one or more techniques of this disclosure, simulation engine 12 may analyze virtual model 14B to determine data indicating sensitivities of an output signal of system 16B to failures of signals of virtual model 14B. Simulation engine 12 may determine several factors to perform the simulation. Some example factors include, but are not necessarily limited to, an attribute (i.e., an output signal) of system 16B to monitor for failure sensitivity, a procedure (i.e., a filtering method) to determine the data, operating conditions under which to determine the data, operating mode under which to determine the data, signals to use to determine the data, which attribute of the signals to vary, levels of disturbance of the signals, and sample runs. In some examples, simulation engine 12 may determine the factors based on user input received from a user of simulator 2. In some examples, simulation engine 12 may determine the factors based on predefined testing protocols.

As discussed above, in some examples, simulation engine 12 may determine an attribute (i.e., an output signal) of system 16B to monitor for failure. In the example of FIGS. 3A and 3B, simulation engine 12 may determine to monitor the voltage across battery cell 30B (i.e., the difference between battery cell plus voltage 94B and battery cell minus voltage 96B) for sensitivity to failures of local signals of virtual model 14B.

In some examples, simulation engine 12 may select a procedure (i.e., a filtering method) to determine the sensitivity measures (i.e., the data). In the example of FIGS. 3A and 3B, simulation engine 12 may use Morris' screen method along with Salltelli's screening method for qualitative sensitivity analysis to determine the data.

Simulation engine 12, in some examples, may determine operating conditions under which to determine the data. In the example of FIGS. 3A and 3B, simulation engine 12 may determine the data under normal ambient temperature.

In some examples, simulation engine 12 may determine an operating mode under which to determine the data. In the example of FIGS. 3A and 3B, simulation engine 12 may determine the data while simulating a constant current charging of battery cells 30.

Simulation engine 12, in some examples, may determine which signals of virtual model 14B to analyze during the filtering process. In the example of FIGS. 3A and 3B, simulation engine 12 is monitoring the voltage across battery cell 30B, as such simulation engine 12 may use signals associated the voltage across battery cell 30B. For instance, simulation engine 12 may use signals associated with OV/UV detectors and ADCs 32, ADCs 34, voltage regulator 74, and voltage reference 76.

As discussed above, in some examples, simulation engine 12 may determine which attribute of the signals to vary. For instance, simulation engine 12 may determine whether a disturbance is added to a voltage amplitude, a current amplitude, or a voltage frequency. In the example of FIGS. 3A and 3B, simulation engine 12 may determine to vary the voltages of the determined signals.

In some examples, simulation engine 12 may determine how much to vary the signals (i.e., levels of disturbances of the signals). For instance, where the determined attribute for a signal is a voltage amplitude, simulation engine 12 may determine to vary the voltage amplitude by plus or minus a percentage of the signal voltage. In the example of FIGS. 3A and 3B, simulation engine 12 may determine to vary the voltages of the determined signals by 25%.

Simulation engine 12, in some examples, may define samples in accordance with the determined procedure. In the example of FIGS. 3A and 3B, as the determined procedure is Morris' screen method along with Salltelli's screening method for qualitative sensitivity analysis, simulation engine 12 may define the samples as discussed above with reference to virtual model 14A. For instance, simulation engine 12 may determine the samples by generating sampling matrices for the signals determine for analysis during the filtering process (i.e., signals associated with OV/UV detectors and ADCs 32, ADCs 34, voltage regulator 74, and voltage reference 76).

In some examples, simulation engine 12 may create test-benches for the defined samples. For instance, simulation engine 12 may create a test bench to enable determination of the sensitivity data for each of the defined samples.

In some examples, simulation engine 12 may perform the simulations on the test benches to determine the sensitivity data. For instance, while simulating virtual model 14B under the determined operating mode and conditions, simulation engine 12 may vary the determined attributes of the signals of virtual model 14B in accordance with the determined levels of disturbances and monitor the behavior of the determined output signal. In the example of FIGS. 3A and 3B, while simulating a constant current charging of battery cells 30 of virtual model 14B at ambient temperature, simulation engine 12 may vary the voltages of the determined signals (i.e., digital overvoltage thresholds 38, digital undervoltage thresholds 40, detector plus voltages 42, detector minus voltages 44, output cell overvoltage flags 46, output cell undervoltage flags 48, ADC plus voltages 50, ADC minus voltages 52, ADC reference voltages 54, output digital fine cell voltages 56, voltage reference input 82, voltage reference output 92, voltage reference ground 88, voltage reference ground reference 90, voltage regulator input 78, voltage regulator disable 86, voltage regulator output 80, and voltage regulator ground 84) one-at-a-time and monitor the resulting voltages across battery cell 30B (i.e., the difference between battery cell plus voltage 94B and battery cell minus voltage 96B).

Simulation engine 12 may generate a distribution of the elementary effects. For instance, simulation engine 12 may generate matrix Fᵢ as the distribution of the elementary effects for samples, where each i-th column of Fᵢ represents the elementary effects of the i-th signal. Simulation engine 12 may determine the relative strength of each i-th signal on the output signal and/or the strength of the i-th signal's interaction with other signals in affecting the voltage across battery cell 30B. In some examples, simulation engine 12 may determine that the mean uᵢ of i-th column is the relative strength of first order effect of i-th signal on the voltage across battery cell 30B. In this way, simulation engine 12 may determine, for respective local signals of virtual model 14A, data indicating a sensitivity of the voltage across battery cell 30B to a failure of the respective local signal. In some examples, simulation engine 12 may determine that the standard deviation σᵢ of i-th column indicates how strong the i-th signal interacts with other signals in affecting the voltage across battery cell 30B. In this way, simulation engine 12 may data indicating a sensitivity of the voltage across battery cell 30B to a combined failure of a first local signal of virtual model 14B and a failure of a second local signal of virtual model 14B.

In some examples, simulation engine 12 may output the data indicating sensitivities of the output signal to failures of the other signals. For instance, simulation engine 12 may cause UI module 13 to output, via one or more of UI devices 6, a graphical user interface (GUI) that includes a representation of the determined data that indicates the sensitivities that the voltage across battery cell 30B would have to failures of the signals of virtual model 14B.

While described in the context of the battery management system, the techniques of this disclosure may be equally applicable to other applications. For instance, the techniques of this disclosure may be used to improve the safety and design of electronics braking systems, acceleration systems, and the like.

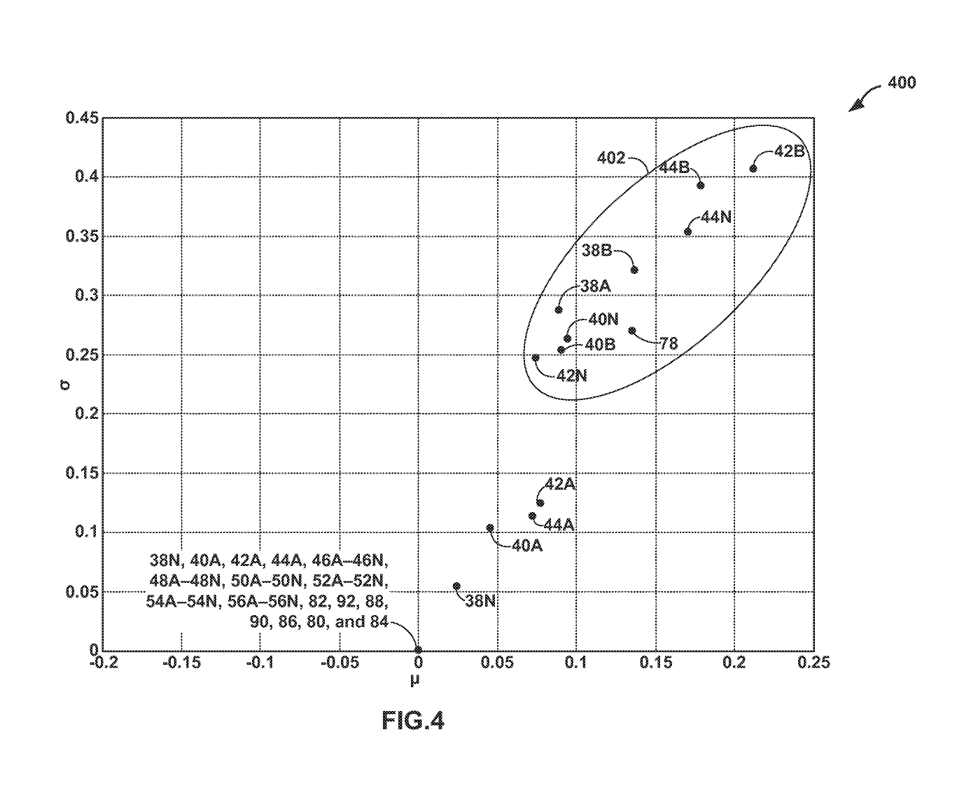

FIG. 4 is a graph illustrating example data indicating sensitivities of an output signal of a system to failures of local signals of the system, in accordance with one or more techniques of this disclosure. Graph 400 may represent example data which may be determined by simulation engine 12 of simulator 2 of FIG. 1. In the example of FIG. 4, graph 400 represents the data determined by simulation engine 12 based on the above-described analysis of virtual model 14B. As illustrated in FIG. 4, graph 400 may include a horizontal axis representing the relative sensitivity of an output signal of a system to a failure of another signal of the system and a vertical axis representing how strong failures of the other signal interact with other signals in affecting the output signal.

As discussed above, the data determined by simulation engine 12 may be useful in identifying signals (and their associated components) for further analysis (e.g., via fault-injection). In some examples, such as the example of FIG. 4, the higher the values, the stronger affect the signal has on the output signal. As such, in some examples, the signals which have the strongest effects on the output signal may be selected for further analysis. In the example of FIG. 4, it can be observed that the nine signals in region 402 (i.e., 38A, 38B, 40B, 40N, 42B. 42N, 44B, 44N, and 78) have relatively stronger effects on the output signal. Similarly, it can be it can be observed that the signals outside of region 402 (i.e., 38N, 40A, 42A, 44A, 46A-46N, 48A-48N, 50A-50N, 52A-52N, 54A-54N, 56A-56N, 82, 92, 88, 90, 86, 80, and 84) have relatively weaker, or no, effects on the output signal. Therefore, in accordance with one or more techniques of this disclosure, simulation engine 12 may determine that signals 38A. 38B, 40B, 40N, 42B. 42N, 44B, 44N, and 78 are potentially safety-critical and identify said signals for further analysis. As such, simulation engine 12 may enable further analysis to be performed on signals that are potentially safety-critical while refraining from performing the further analysis on signals that are not potentially safety-critical. In this way, simulation engine 12 may reduce the amount of time taken to analyze a system.

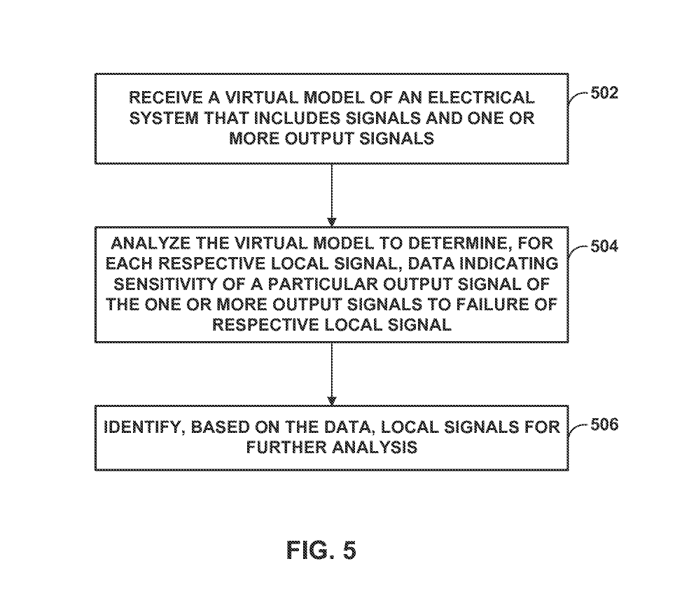

FIG. 5 is a flowchart illustrating exemplary operations of a simulator to determine data indicating sensitivities of an output signal of a system to failures of other signals of the system, in accordance with one or more techniques of this disclosure. For purposes of illustration only, the example operations are described below within the context of simulator 2 as shown in FIG. 1.

In accordance with one or more techniques of this disclosure, simulator 2 may receive a virtual model of an electrical system that includes the signals and one or more output signals (502). For instance, simulator 2 may receive virtual model 14B of system 16B.

Simulator 2 may analyze the virtual model to determine, for each respective signal of the plurality of signals within the system, data indicating a sensitivity of a particular output signal of the one or more output signals to a failure of the respective signal (504). For instance, processors 4 may execute simulation engine 12 to analyze virtual model 14 to determine, for each respective signal of signals 38A-38N, 40A-40N, 42A-42N, 44A-44N, 46A-46N, 48A-48N, 50A-50N, 52A-52N, 54A-54N, 56A-56N, 78, 82, 92, 88, 90, 86, 80, and 84, data indicating a sensitivity of the voltage across battery cell 30B of FIG. 3A to a failure of the respective signal.

Simulator 2 may identify, based on the data, one or more of the signals for further analysis (506). As one example, processors 4 may execute simulation engine 12 to identify a sub-set of the plurality of signals having failures to which the output signal is most sensitive for further analysis (e.g., signals 38A, 38B, 40B. 40N, 42B, 42N, 44B, 44N, and 78). As another example, processors 4 may execute simulation engine 12 to output, for display at one of UI devices 6 of simulator 2, a graphical user interface (GUI) that includes a representation of the determined data that indicates the sensitivities of the output signal to the failures of the other signals. As such, simulation engine 12 may enable further analysis to be performed on signals to which the output signal is most sensitive (i.e., signals that are potentially safety-critical) while refraining from performing the further analysis on signals to which the output signal is not as sensitive. In this way, simulation engine 12 may reduce the amount of time taken to analyze a system.

The following numbered examples may illustrate one or more aspects of the disclosure:

### Example 1

A method comprising: receiving, by one or more processors, a virtual model of an electrical system that includes a plurality of signals and one or more output signals; analyzing, by the one or more processors, the virtual model to determine, for each respective signal of the plurality of signals, data indicating a sensitivity of a particular output signal of the one or more output signals to a failure of the respective signal; and outputting, by the one or more processors and for display, a visual representation of the determined data that indicates the sensitivities of the particular output signals to the failures of the plurality of signals.

### Example 2

The method of example 1, further comprising: determining, by the one or more processors, data indicating a sensitivity of the particular output signal to a combined failure of a first signal of the plurality of signals and a failure of a second signal of the plurality of signals; and outputting, by the one or more processors and for display, a visual representation of the determined data that indicates the sensitivity of the particular output signal to the combined failure of the first signal and the failure of the second signal.

### Example 3

The method of any combination of examples 1-2, wherein analyzing the virtual model comprises simulating failures of the signals by at least altering the signals.

### Example 4

The method of any combination of examples 1-3, further comprising: identifying, by the one or more processors and for further analysis, a sub-set of the plurality of signals having failures to which the particular output signal is most sensitive, wherein the representation of the determined data included in the GUI includes an indication of which signals are included in the identified sub-set.

### Example 5

The method of any combination of examples 1-4, wherein the plurality of signals include one or more analog signals.

### Example 6

The method of any combination of examples 1-4, wherein the plurality of signals include one or more digital signals.

### Example 7

The method of any combination of examples 1-4, wherein the plurality of signals include one or more analog signals and one or more digital signals.

### Example 8

A non-transitory computer-readable storage medium storing instructions that, when executed, cause one or more processors to: receive a virtual model of an electrical system that includes a plurality of signals and one or more output signals; analyze the virtual model to determine, for each respective signal of the plurality of signals, data indicating a sensitivity of a particular output signal of the one or more output signal to a failure of the respective signal; and output, for display, a visual representation of the determined data that indicates the sensitivities of the particular output signal to the failures of the plurality of signals.

### Example 9

The non-transitory computer-readable storage medium of example 8, further comprising instructions that cause the one or more processors to: determine data indicating a sensitivity of the particular output signal to a combined failure of a first signal of the plurality of signals and a failure of a second signal of the plurality of signals; and output, for display, a visual representation of the determined data that indicates the sensitivity of the particular output signal to the combined failure of the first signal and the failure of the second signal.

### Example 10

The non-transitory computer-readable storage medium of any combination of examples 8-9, wherein the instructions that cause the one or more processors to analyze the virtual model comprise instructions that cause the one or more processors to simulate failures of the signals by at least altering the signals.

### Example 11

The non-transitory computer-readable storage medium of any combination of examples 8-10, further comprising instructions that cause the one or more processors to: identify, for further analysis, a sub-set of the plurality of signals having failures to which the particular output signal is most sensitive, wherein the representation of the determined data included in the GUI includes an indication of which signals are included in the identified sub-set.

### Example 12

The non-transitory computer-readable storage medium of any combination of examples 8-11, wherein the plurality of signals include one or more analog signals.

### Example 13

The non-transitory computer-readable storage medium of any combination of examples 8-11, wherein the plurality of signals include one or more digital signals.

### Example 14

The non-transitory computer-readable storage medium of any combination of examples 8-11, wherein the plurality of signals include one or more analog signals and one or more digital signals.

### Example 15

A system comprising: a memory storing a virtual model of an electrical system that includes a plurality of signals and one or more output signals; and one or more processors configured to: analyze the virtual model to determine, for each respective signal of the plurality of signals, data indicating a sensitivity of a particular output signal of the one or more output signals to a failure of the respective signal; and output, for display, a visual representation of the determined data that indicates the sensitivities of the particular output signal to the failures of the plurality of signals.

### Example 16

The system of example 15, wherein the one or more processors are further configured to: determine data indicating a sensitivity of the particular output signal to a combined failure of a first signal of the plurality of signals and a failure of a second signal of the plurality of signals; and output, for display, a visual representation of the determined data that indicates the sensitivity of the particular output signal to the combined failure of the first signal and the failure of the second signal.

### Example 17

The system of any combination of examples 15-16, wherein, to analyze the virtual model, the one or more processors are configured to simulate failures of the signals by at least altering the signals.

### Example 18

The system of any combination of examples 15-17, wherein the one or more processors are further configured to: identify, for further analysis, a sub-set of the plurality of signals having failures to which the particular output signal is most sensitive, wherein the representation of the determined data included in the GUI includes an indication of which signals are included in the identified sub-set.

### Example 19

The system of any combination of examples 15-18, wherein the plurality of signals include either one or more analog signals or one or more digital signals.

### Example 20

The system of any combination of examples 15-18, wherein the plurality of signals include one or more analog signals and one or more digital signals.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A method comprising:
receiving, by one or more processors, a virtual model of an electrical system that includes a plurality of signals and one or more output signals;
analyzing, by the one or more processors, the virtual model to determine, for each respective signal of the plurality of signals, data indicating a sensitivity of a particular output signal of the one or more output signals to a failure of the respective signal; and
outputting, by the one or more processors and for display, a visual representation of the determined data that indicates the sensitivities of the particular output signals to the failures of the plurality of signals.

2. The method of claim 1, further comprising:
determining, by the one or more processors, data indicating a sensitivity of the particular output signal to a combined failure of a first signal of the plurality of signals and a failure of a second signal of the plurality of signals; and
outputting, by the one or more processors and for display, a visual representation of the determined data that indicates the sensitivity of the particular output signal to the combined failure of the first signal and the failure of the second signal.

3. The method of claim 1, wherein analyzing the virtual model comprises simulating failures of the signals by at least altering the signals.

4. The method of claim 1, further comprising:
identifying, by the one or more processors and for further analysis, a sub-set of the plurality of signals having failures to which the particular output signal is most sensitive,
wherein the representation of the determined data included in the GUI includes an indication of which signals are included in the identified sub-set.

5. The method of claim 1, wherein the plurality of signals include one or more analog signals.

6. The method of claim 1, wherein the plurality of signals include one or more digital signals.

7. The method of claim 1, wherein the plurality of signals include one or more analog signals and one or more digital signals.

8. A non-transitory computer-readable storage medium storing instructions that, when executed, cause one or more processors to:
receive a virtual model of an electrical system that includes a plurality of signals and one or more output signals;
analyze the virtual model to determine, for each respective signal of the plurality of signals, data indicating a sensitivity of a particular output signal of the one or more output signal to a failure of the respective signal; and
output, for display, a visual representation of the determined data that indicates the sensitivities of the particular output signal to the failures of the plurality of signals.

9. The non-transitory computer-readable storage medium of claim 8, further comprising instructions that cause the one or more processors to:
determine data indicating a sensitivity of the particular output signal to a combined failure of a first signal of the plurality of signals and a failure of a second signal of the plurality of signals; and
output, for display, a visual representation of the determined data that indicates the sensitivity of the particular output signal to the combined failure of the first signal and the failure of the second signal.

10. The non-transitory computer-readable storage medium of claim 8, wherein the instructions that cause the one or more processors to analyze the virtual model comprise instructions that cause the one or more processors to simulate failures of the signals by at least altering the signals.

11. The non-transitory computer-readable storage medium of claim 8, further comprising instructions that cause the one or more processors to:
identify, for further analysis, a sub-set of the plurality of signals having failures to which the particular output signal is most sensitive,
wherein the representation of the determined data included in the GUI includes an indication of which signals are included in the identified sub-set.

12. The non-transitory computer-readable storage medium of claim 8, wherein the plurality of signals include one or more analog signals.

13. The non-transitory computer-readable storage medium of claim 8, wherein the plurality of signals include one or more digital signals.

14. The non-transitory computer-readable storage medium of claim 8, wherein the plurality of signals include one or more analog signals and one or more digital signals.

15. A system comprising:
a memory storing a virtual model of an electrical system that includes a plurality of signals and one or more output signals; and
one or more processors configured to:
analyze the virtual model to determine, for each respective signal of the plurality of signals, data indicating a sensitivity of a particular output signal of the one or more output signals to a failure of the respective signal; and
output, for display, a visual representation of the determined data that indicates the sensitivities of the particular output signal to the failures of the plurality of signals.

16. The system of claim 15, wherein the one or more processors are further configured to:
determine data indicating a sensitivity of the particular output signal to a combined failure of a first signal of the plurality of signals and a failure of a second signal of the plurality of signals; and
output, for display, a visual representation of the determined data that indicates the sensitivity of the particular output signal to the combined failure of the first signal and the failure of the second signal.

17. The system of claim 15, wherein, to analyze the virtual model, the one or more processors are configured to simulate failures of the signals by at least altering the signals.

18. The system of claim 15, wherein the one or more processors are further configured to:
identify, for further analysis, a sub-set of the plurality of signals having failures to which the particular output signal is most sensitive,
wherein the representation of the determined data included in the GUI includes an indication of which signals are included in the identified sub-set.

19. The system of claim 15, wherein the plurality of signals include either one or more analog signals or one or more digital signals.

20. The system of claim 15, wherein the plurality of signals include one or more analog signals and one or more digital signals.
